(19) United States
(12) Patent Application Publication
(10) Pub. No.: US 2005/0240523 A1
(43) Pub. Date: Oct. 27, 2005

(54) Method of remotely filling a prescription for a patient

(75) Inventors: Kent A. Richardson, Derby, KS (US); Susan K. Richardson, Derby, KS (US); Constance S. Aldrich, Council Grove, KS (US); Kenneth J. Aldrich, Council Grove, KS (US)

Correspondence Address: HOVEY WILLIAMS LLP, Suite 400, 2405 Grand Blvd., Kansas City, MO, 64108, US

(73) Assignee: MDDC, Inc.

(21) Appl. No.: 10/832,114

(22) Filed: Apr. 26, 2004

(51) Int. Cl. G06F 17/60

(52) U.S. Cl. 705/40

(57) ABSTRACT

A method of remotely filling a prescription for a patient is disclosed which comprises the steps of: (a) receiving a patient's prescription for a drug, medicine, or other treatment (100); (b) performing at least one drug utilization review based on the prescription (102); (c) filling the prescription (104); (d) providing the filled prescription to a local pharmacy (106); and (e) receiving payment for the filled prescription from the patient (108). Thus, the method combines the services and counseling available from a local pharmacy with the convenience and price associated with a mail-order pharmacy.

### BACKGROUND OF THE INVENTION

1. Field of the Invention

The present invention relates to a method of remotely filling a prescription for a patient. More particularly, the invention relates to a method of remotely filling a prescription for a patient by utilizing a remote filling station which receives the patients prescription, provides the filled prescription to a local pharmacy, and receives payment from the patient.

2. Description of the Prior Art

Rapid advances in heath care have made available a vast array of medicines, drugs, pharmaceuticals, and treatments for patients seeking medical treatment. Typically, a patient receives a prescription from a medical professional, such as a doctor or a nurse practitioner, and proceeds to a local pharmacy to fill and purchase the prescription. Generally, the local pharmacy is located near the patient's residence, place of business, or in an otherwise convenient location.

Unfortunately, this typical prior art method of purchasing a prescription from a local pharmacy suffers from a number of disadvantages. First, the local pharmacy may have a limited selection of medicines, drugs, and other treatments, thereby requiring the patient to expend considerable time searching for a local pharmacy which has the capabilities to fill the prescription. Second, the local pharmacy may charge a price for the prescription which is greater than the price the patient would be charged at a different local pharmacy, thereby forcing the patient to pay the greater price or expend considerable time searching for a pharmacy with a suitable price.

To overcome these limitations, additional prior art methods have been developed, such as mail-order pharmacies and “central fill” pharmacies. Mail-order pharmacies receive prescriptions mailed to them by a patient. The mail-order pharmacy then fills the prescription and mails the filled prescription to the patient in one to two weeks. In the central-fill method, utilized primarily by commonly-owned chain pharmacies, the local pharmacy sends a prescription to a remote central fill pharmacy, which fills and returns the prescription to the local pharmacy where the patient receives the prescription. Central-fill methods are becoming increasingly popular due to the lower cost of filling prescriptions at the automated central fill pharmacy and the shortage of pharmacist manpower at the local pharmacies.

However, mail-order and central-fill methods still suffer from a number of disadvantages. First, the mail-order pharmacies generally provide little guidance or assistance to the patient regarding the filled prescription. Further, the patient is often unable, or unwilling to expend any additional time in calling a 1-800 number, to ask questions regarding the use of the filled prescription, its possible side effects, possible interactions with other drugs, possible alternative treatments, etc. In contrast, when prescriptions are dispensed at a local pharmacy, a patient may usually speak at length with a local pharmacist at the local pharmacy regarding any number of questions, and be counseled by the local pharmacist on the use of the filled prescription. Thus, the mail-order pharmacies may subject the patient to a danger, from harmful side effects or drug interactions, which can be avoided when visiting the local pharmacy.

Also, mail-order pharmacies, due to the large number of patients served and the inability to easily communicate with each patient, are generally unaware of the specific needs and complete medical history of each patient. In contrast, a local pharmacy is generally aware of the specific needs and medical history of each patient, due to the lower number of patients the local pharmacy serves, the ability to easily communicate with each patient, and the fact that a patient traditionally has every prescription filled by the same local pharmacy. Thus, mail-order pharmacies may subject the patient to additional dangers due to the lack of complete information available to the mail-order pharmacies.

Second, while central fill pharmacies can decrease costs and relieve pressure on pharmacist manpower, a local pharmacy using a central fill pharmacy must still purchase the drugs, price the prescription or submit the claims to a third party for pricing, enter the complete prescription in their computer system, and subject themselves to audits from third parties which provide payment.

Accordingly, there is a need for an improved method of remotely filling a prescription. More particularly, there is a need for an improved method which combines the services and counseling available from a local pharmacy with the convenience and price available from a mail-order pharmacy. Specifically, there is a need for a method which allows a patient to fill and purchase a prescription from a remote pharmacy and receive the filled prescription at a local pharmacy where counseling is provided.

Additionally, there is a need for a method which allows a patient to enjoy the selection and price of a mail-order pharmacy without subjecting the patient to dangerous interactions or side effects which may occur in unsupervised prescription purchases.

Furthermore, there is a need for a method which allows a local pharmacy to offer the selection and benefits of a “central fill” pharmacy method without requiring the local pharmacy to purchase drugs to fill each prescription, price each prescription, or be subjected to audits from third parties who provide payment.

### SUMMARY OF THE INVENTION

The present invention solves the above-described problems and provides a distinct advance in the art of remotely filling prescriptions. More particularly, the invention provides a method of remotely filling a prescription for a patient by utilizing a remote filling station which receives the patients prescription, provides the filled prescription to a local pharmacy, and receives payment from the patient.

The method of the present invention broadly includes the steps of (a) receiving a patient's prescription for a drug, medicine, or other treatment; (b) performing at least one drug utilization review based on the prescription; (c) filling the prescription; (d) providing the filled prescription to a local pharmacy; and (e) receiving payment for the filled prescription from the patient. The local pharmacy is preferably a pharmacy which the patient may physically access for direct consultation with a local pharmacist.

The patient's prescription is preferably received by computing equipment operated by a computer program which has access to a network connection. Specifically, the local pharmacy may create an electronic copy of the prescription by scanning the prescription using known and conventional methods, which may then be received through e-mail, a web-site, a file server, a fax, etc. Additional information, such as the name of the patient, the prescribed treatment, the name of the prescribing medical professional, the name of the local pharmacist, etc, is also received to confirm the contents of the received prescription.

Upon receiving the prescription, the prescription is priced and one or more drug utilization reviews are performed. Drug utilization review is the process by which prescribed medications, drugs, and treatments, are evaluated against explicit criteria to improve the quality of therapy, reduce unnecessary expenditures, prevent adverse drug interactions, and identify potentially inappropriate prescribing, as is well known in the art. Each drug utilization review may be performed by the computer program or by a first remote pharmacist associated with the method. Additionally, the result of each drug utilization review may be provided to the local pharmacy through the computer program.

The prescription may be filled once the one or more drug utilization reviews are completed. The prescriptions are preferably filled by an automated filling system, which is a commonly available system which interfaces with the computing equipment and computer program to direct a labeled vial to a proper location for filling with the prescribed drug, medicine, treatment, etc. The filled prescription may then be transported to a second remote pharmacist who verifies its contents.

The filled prescription is placed in a tamper evident package, along with a patient document, a pharmacist document, and a non-reproducible copy of the prescription, and sent to the local pharmacy. The patient document and pharmacist document respectively counsel the patient and provide the pharmacist with information on the use of the prescribed treatment. The non-reproducible copy of the prescription and accompanying documents provide a record of the transaction for the local pharmacy and patient while ensuring that the prescription may not be improperly reused to fill additional prescriptions.

Payment for the filled prescription is received from the patient. The payment from the patient may be received through a third party payer, such as an insurance or health care provider. The payment may be received through any conventional method at any time in the process, such as when the prescription is received, when the prescription is filled, or when the patient receives the prescription. Additionally, the payment may be received by the computer program, such that the payment is automated.

The method of the present invention as described herein has numerous advantages over the prior art. First, the method combines the services and counseling available from a local pharmacy with the convenience and price available from a mail-order pharmacy. Specifically, the method allows a patient to fill and purchase a prescription from a remote pharmacy and receive the filled prescription at local pharmacy where counseling is provided by a local pharmacist. Additionally, the method allows a patient to have the selection and price of a mail-order pharmacy without subjecting the patient to the dangerous interactions or side effects which may occur in unsupervised prescription purchases. Furthermore, the method allows a local pharmacy to offer the selection and benefits of a “central fill” pharmacy method without requiring the local pharmacy to purchase drugs to fill each prescription, price each prescription, or be subjected to audits from third parties who provide payment

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a plan view of equipment utilized by the method of the present invention;

FIG. 2 is a flow chart showing some of the steps performed when implementing the method of the present invention; and

FIG. 3 is a flow chart showing some of the additional steps performed when implementing the method of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

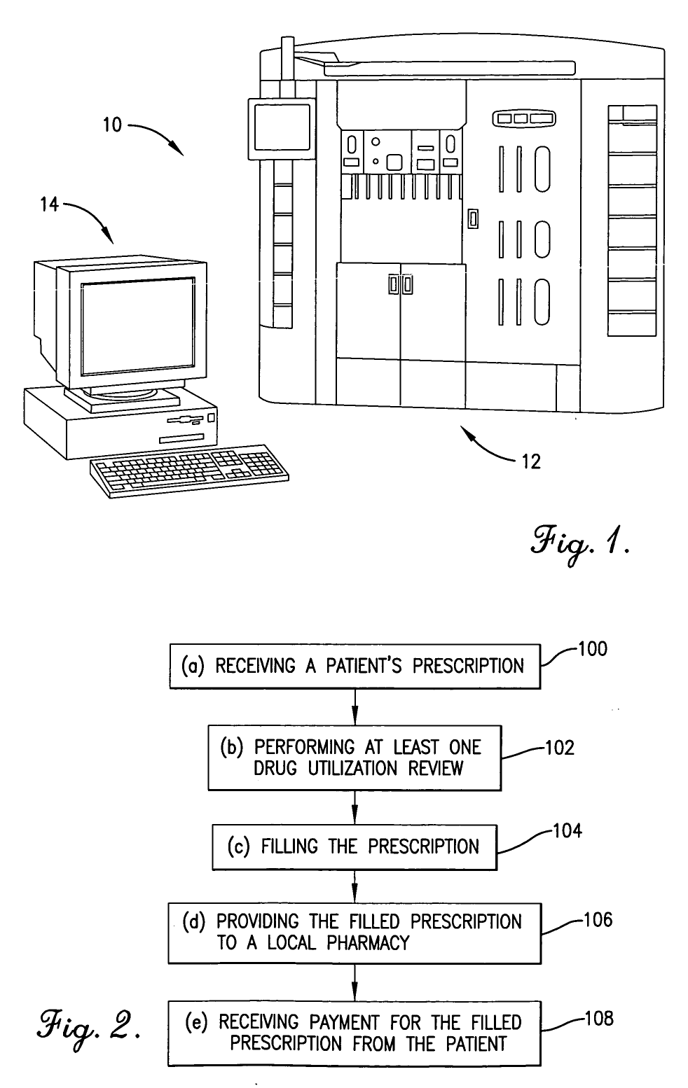

The method of the present invention is preferably implemented by using equipment 10 as shown in FIG. 1. The equipment 10 includes a filling system 12 and computing equipment 14. Preferably, the filling system 12 is any commonly known automated system which fills a prescription based on at least one input. Specifically, the filling system 12 is preferably an “S/I BAKER” automated filling system, which is a commonly available system that utilizes bar codes and radio frequencies to direct a labeled vial to a proper location for filling with a prescribed drug, medicine, treatment, etc. However, the filling system 12 may be any known method or manner of filling a prescription, including manual filling methods.

The computing equipment 14 is controlled by a computer program and is adapted to interface with the filling system 12 such that the computing equipment 14 controls the operation and functionality of the filing system 12. The computing equipment 14 may include computing devices, computer software, hardware, firmware, or any combination thereof. In a preferred embodiment, however, the computing equipment 14 includes any computing device such as a personal computer, a network computer running WINDOWS, NOVEL NETWARE, UNIX, LINUX, or any other network operating system, a computer network comprising a plurality of computers, a mainframe or distributed computing system, a portable computing device, or any combination thereof.

The computing equipment 14 is equipped with a communications connection including a network connection, such as a wired or wireless connection to the Internet, to allow the computing equipment 14 to communicate with other computers, devices, networks, equipment, etc. The computing equipment 14 also preferably includes internal or external memory for storing information, such as electronic files, directories, listings, or databases.

The filling system 12, computing equipment 14 and computer program illustrated and described herein are merely examples of a device and a program that may be used to implement the present invention and may be replaced with other devices and programs without departing from the scope of the present invention.

The computer program described herein controls input to the computing equipment 14 and the operation of the computing equipment 14. The computer program is stored in or on a computer-readable medium residing on or accessible by the computing equipment 14 for instructing the filling system 12, computing equipment 14, and any other related components to operate as described herein. The computer program preferably comprises an ordered listing of executable instructions for implementing logical functions in the computing equipment 10. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

Preferably, the computer program includes, or is interfaced with, a web server for hosting a web-site, including at least one web page, in a substantially conventional manner, which allows the web-site to be accessed by the computing equipment 14 and other equipment or devices which are connected to the computing equipment 14 through the network connection. The web server, as part of the computer program, is operable to access, store, modify, or delete information stored on the computing equipment 14. Thus, the web-server has access to the computing equipment 14 and associated computer-readable medium. Additionally, the computer program may include a conventional file server for receiving or sending electronic files.

In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, a portable compact disc read-only memory (CDROM), a portable digital video disc read-only memory (DVD-ROM), a medium accessible through a computing network, such as the Internet, etc. The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The functionality and operation of a preferred implementation of the method is described below. In this regard, some of the described functionality may represent a step or a module segment or portion of code of the computer program of the present invention which comprises one or more executable instructions for implementing the specified logical function or functions. In some alternative implementations, the steps or functions described may occur out of the order described below. For example, steps or functionalities described in succession may in fact be executed substantially concurrently, or the steps or functionalities may sometimes be executed in the reverse order depending upon the functionality involved.

As shown in FIG. 2, a preferred embodiment of the present invention broadly includes the steps of (a) receiving a patient's prescription, referenced at step 100 in FIG. 2; (b) performing at least one drug utilization review based on the prescription, referenced at step 102 in FIG. 2; (c) filling the prescription, referenced at step 104 in FIG. 2; (d) providing the filled prescription to a local pharmacy, referenced at step 106 in FIG. 2; and (e) receiving payment for the filled prescription from the patient, referenced at step 108 in FIG. 2.

The prescription, as is commonly known in the art, is a written or printed instruction for a medicine, drug, treatment, etc, which is issued by a medical professional to the patient. The local pharmacy may be located near the patient's residence, place of business, or an otherwise convenient location, and employs at least one local pharmacist. However, the local pharmacy may be any pharmacy which the patient may access for consultation.

Step 100 in FIG. 2, receiving the prescription, may be accomplished by one or more methods. For instance, the patient may mail or otherwise send the prescription through U.S. mail or other carrier services; the local pharmacy may mail or send the prescription; a doctor may mail or send the prescription; the patient, local pharmacy, or doctor may transmit the prescription by facsimile through conventional means; etc.

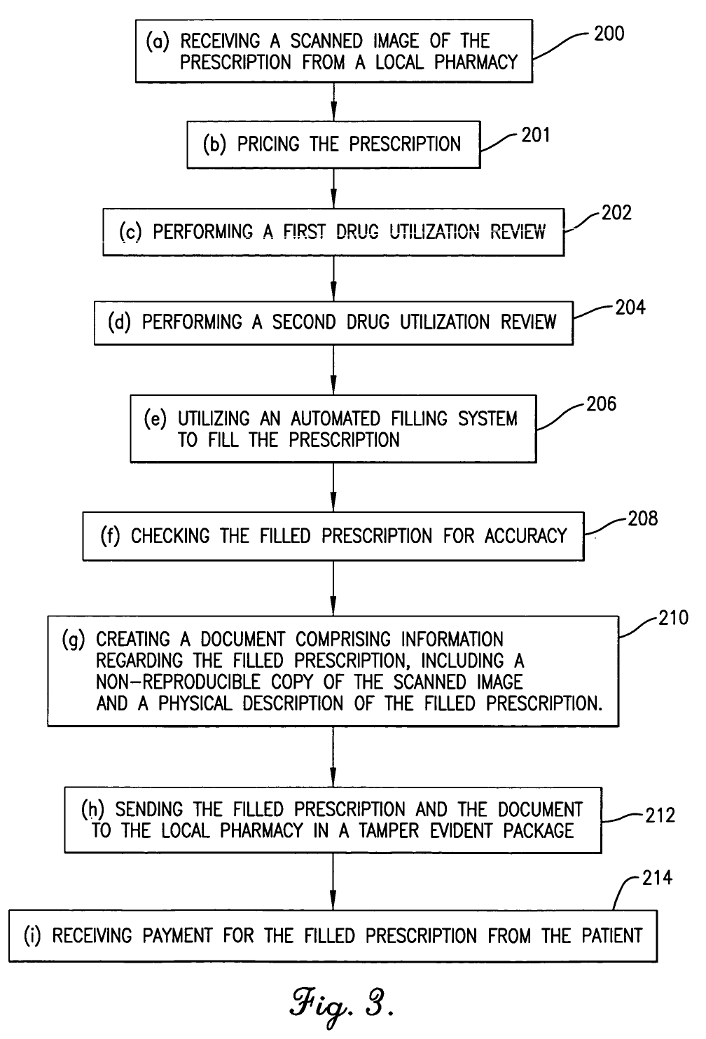

Preferably, the prescription is received through electronic means by utilizing the computing equipment 14 and computer software. For instance, the computing equipment 14 may receive the prescription through the network connection. Specifically, the patient, local pharmacy, or medical professional, may create an electronic copy of the prescription by scanning the prescription using known and conventional means, as is referenced at step 200 in FIG. 3. The electronic copy of the prescription is preferably received in a conventional digital image format, such as TIFF, GIF, JPEG, BMP, PDF, etc. Additionally, the electronic copy of the prescription may be received through facsimile.

The patient, local pharmacy, or medical professional may transmit the electronic copy of the prescription through conventional means to the computing equipment 14 through the network connection, such as by transmitting the electronic copy to the computer software, attaching the electronic copy to an e-mail, uploading the electronic copy to the web-server operating on the computing equipment 14, uploading the electronic copy to the file-server operating on the computing equipment 14, sharing the electronic copy on a computing network such that the computing equipment 14 may access the electronic copy, etc.

In addition to receiving the prescription, additional information relevant to the prescription, such as a name of the patient, a name of the medical professional who issued the prescription, an initial of the medical professional, the name of the prescribed drug, medicine, or treatment, and a name or initials of the local pharmacist, is preferably also received. The additional information helps ensure that the information in the prescription is accurate and valid by reducing the probability of error in reading, transcribing, or receiving the prescription.

The additional information may be received through the methods described above, such as through U.S. Mail or electronic means by utilizing the computing equipment 14 and computer software. Thus, the additional information may be received in the same manner as the electronic copy of the prescription, and may be received at substantially the same time.

Preferably, the electronic copy of the prescription and the additional information is received through the web-site stored on the web server, which facilitates the transmission of the electronic copy. For instance, the web-site may include a page having a “Fill Script” prompt, logo, button, etc, which initiates the transfer process. The local pharmacist may simply click on “Fill Script”, scan the prescription or provide the electronic location of the electronic copy of the prescription, and input the additional information, which allows the web-site to receive the prescription and additional information. Alternatively, the patient may be allowed to access the web-site to order the prescription.

The computer program of the present invention, comprising the web-site, may additionally allow the local pharmacy, local pharmacist and/or the patient to enroll and create user accounts, each having an individual login name and password. Each patient account preferably includes data relevant to the patient, such as the patient's name, mailing address, contact information, billing information, insurance information, previous prescriptions filled for the patient, pending prescriptions to be filled for the patient, medical history, attending physician, and any other relevant heath care information. Each local pharmacy and local pharmacist account preferably includes similar information, such as the name of the pharmacy or pharmacist, mailing addresses, contact information, billing information, insurance information, previous prescriptions filled for the pharmacy, pending prescriptions to be filled for the pharmacy, etc. Thus, the relevant information is permanently stored for future use and reference, thereby allowing the patient and local pharmacy to place repeat orders for prescriptions, without being required to repeatedly input the information. Additionally, the information stored in the accounts facilitates the drug utilization review, as described below.

After receiving the prescription, the prescription is priced or adjudicated to provide an allowed cost and price for the prescription, as is referenced at step 201 in FIG. 3. Preferably, the prescription is priced by a third party benefit management company (PBM) which returns the allowed cost and price for the prescription. The prescription may be provided to the PBM through conventional means, such as telephone, facsimile, U.S. Mail, etc. Preferably, the computer program provides the PBM with the name or national drug code (NDC) number of the prescribed treatment. The computer program may communicate with the PBM through the conventional electronic means described above, such as the web-site, email, file-server, etc. Similarly, the PBM may return the allowed cost and price of the prescription utilizing facsimile, U.S. Mail, or the computer program.

The allowed cost and price of the prescription may be provided to the local pharmacy, local pharmacist, or patient through the methods described above, such as telephone, facsimile, U.S. Mail, the computer program, etc. Preferably, the computer program provides the allowed cost and price to the local pharmacy, local pharmacist, or patient through the web-site, thereby allowing the allowed cost and price to be provided in an expedient manner soon after the prescription has been received.

Step 102 in FIG. 2, performing at least one drug utilization review based on the prescription, may be performed once the prescription is received in step 100. Drug utilization review (DUR) is the process by which prescribed medications, drugs, and treatments, are evaluated against explicit criteria to improve the quality of therapy, reduce unnecessary expenditures, prevent adverse drug interactions, and identify potentially inappropriate prescribing. DUR is well known in the art, and may be accomplished through a variety of common methods and practices. In general, DUR comprises matching the prescribed treatment with the health care information stored in the patient's account and checking for harmful interactions based on known information stored in a database, which is accessible by the computing equipment 14.

Preferably, a first DUR is performed by the computer program once the prescription is received, as is referenced at step 202 in FIG. 3. The results of the first DUR, performed by the computer program, are accessible by the local pharmacy, local pharmacist, and/or the patient through the computing equipment 14 and network connection, as described above. For instance, the web-site accessed by the local pharmacy, local pharmacist, or patient may indicate the results of the first DUR through the “Fill Script” function described above, or the web-site may provide additional functionality, such as a “Check DUR” or “Check First DUR” functionality to provide the results of the first DUR.

If the first DUR indicates that there are harmful interactions or other problems with the prescription, the results are indicated as described above and the prescription is not filled. The local pharmacy, local pharmacist, and patient accounts may additionally record the first DUR failure for future reference. If the first DUR indicates that there are not harmful interactions or other problems with the prescription, the result is indicated as described above.

Upon passing the first DUR, a first remote pharmacist associated with the method reviews the received prescription, preferably as a scanned image as described above, and compares the received prescription to the additional information provided by the local pharmacy. If the received prescription matches the additional information provided by the local pharmacy, the first remote pharmacist performs a second DUR, as is referenced at step 204 in FIG. 3, which is similar to the first DUR. However, the second DUR may utilize a different process, method, or computer program, than the first DUR to ensure that the results of the first DUR are valid and accurate. The results of the second DUR are communicated to the local pharmacy, local pharmacist, or patient in the substantially same manner as the results of the first DUR, and results of the second DUR may be stored in substantially the same manner as the results of the first DUR. At least one additional DUR may be performed by the third party benefit management company (PBM) which provides the allowed cost and price for the prescription. The DUR performed by the PBM is substantially similar to the first and second DUR, and the results of the DUR performed by the PBM are received in substantially the same manner as the results of the first and second DUR.

Step 104 in FIG. 2, filling the prescription, may be performed once at least one DUR is performed. Generally, the automated filling system 12 receives the prescription and automatically fills the prescription to create a filled prescription container in a known and conventional manner, as is referenced at step 206 in FIG. 3. Preferably, the computing equipment 14 and computer program provide the relevant prescription information, such as the name of the treatment and the amount of the treatment required, to the filling system 12 to facilitate the transaction. However, the filling system 12 may be provided with the prescription through other means, such as having the remote pharmacist manually fill the prescription, etc.

Preferably, the computer program stores data regarding the filling of each prescription in a database or other computer storage medium such that a record is created which may be accessed by the computer program or other users, to determine the amount of inventory accessible by the filling system 12. The amount of inventory may be accessible by the local pharmacy, local pharmacist, or patient through the means described above, such as through the web-site. Thus, the local pharmacy, local pharmacist, or patient may be notified if the prescription cannot be filled when the prescription is received.

The filled prescription container is transported to a second remote pharmacist, who checks the prescription for accuracy by comparing the drug, medicine, or treatment contained in the filled prescription container with a picture of the drug, medicine, or treatment which is displayed by the filling system 12 or computing equipment 14, as is referenced at step 208 in FIG. 3. Additionally, a physical description of the drug, medicine, or treatment is included on the container's label.

After verification by the second remote pharmacist, a detailed patient document is created to inform the patient about the prescription. The document includes such information as the side effects and complications of the prescription, possible harmful interactions, directions for use, etc. Preferably, the patient document is created by the computer software, which accesses a database containing the information, and is printed by the computing equipment 12.

In addition to the patient document, a local pharmacist document is created which includes counseling tips for the local pharmacist. The counseling tips includes such information as the side effects and complications of the prescription, possible harmful interactions, directions for use, etc. Preferably, the pharmacist document is created by the computer software, which accesses a database containing the needed information, and is printed by the computing equipment 12.

In addition to the patient document and pharmacist document, a non-reproducible copy of the prescription is created, as is referenced at step 210 in FIG. 3. The non-reproducible copy of the prescription provides a record of the transaction for the local pharmacy, local pharmacist or patient while ensuring that the prescription may not be reused to improperly fill additional prescriptions. Preferably, the non-reproducible copy of the prescription is created by the computer software, which accesses the electronic copy of the prescription which was received in step 100 in FIG. 2.

The filled prescription container, patient document, pharmacist document, and non-reproducible copy of the prescription are preferably sealed in a tamper evident package which is delivered to the local pharmacy, referenced at step 212 in FIG. 3. The tamper evident packages alerts the local pharmacy to the theft, alteration, or replacement of the filled prescription before the prescription is provided to the patient, thereby reducing the probability that the patient improperly consumes a drug, medicine, or treatment other than the drug, medicine, or treatment prescribed by the medical professional and filled by the filling system 12.

As represented by step 106 in FIG. 2, the sealed tamper evident package is sent to the local pharmacy through conventional means, such as U.S. Mail or other courier services. Preferably, the tamper evident package is sent to the local pharmacy in the most expedient manner, such as by next-day air or other similar methods. Additionally, if the local pharmacy has ordered more than one prescription, the plurality of tamper evident packages may be boxed together for shipment.

The local pharmacist checks the filled prescription container for accuracy and verifies that the contents of the filled prescription are correct by comparing the contents to the printed image and description on the container label. After verifying the contents of the filled prescription, the local pharmacist provides the filled prescription container and the patient document to the patient, and counsels the patient in a conventional manner on the use of the drug, medicine, or treatment. Thus, the patient receives counseling regarding the prescription from both the local pharmacist and the patient document and is also afforded an opportunity to personally speak in depth with a local pharmacist regarding the prescription.

As represented by step 108 of FIG. 2 or step 214 of FIG. 3, payment for the filled prescription is received from the patient. The payment may be received at any time in the process, such as when the prescription is received, when the prescription is filled, or when the patient receives the prescription. Payment may be through conventional methods, such by cash, check, debit card, credit card, etc. Preferably, payment is received by the computer program through the web-site, such that the patient may enter billing information, such as a credit card number and health insurance information, which is charged when the prescription is received, filled, received by the patient, etc.

Alternatively, the payment from the patient may be made through a third party payer, such as the patient's insurance provider, heath care provider, a pharmacy benefit management company, or any other entity responsible for the patient's medical or heath care related expenses. Thus, payment from a patient having prescription drug coverage may be received through the third party payer, using the method described above, such that the patient is not responsible for paying the total cost, or any cost, of the prescription.

Additionally, as described above, the billing information may be permanently stored in a database accessible by the computer program and web-site, such that the patient is not required to enter billing information for each prescription. Instead, the patient may be automatically billed for each prescription. Therefore, the local pharmacy is not directly involved in the payment by the patient for the prescription.

However, the local pharmacy may be paid a per prescription fee for services rendered by the local pharmacy including counseling the patient. Alternatively, payment may be received from the local pharmacy, which collects payment for the prescription from the patient in a conventional manner. Payment may be received from the local pharmacy in substantially the same manner as payment is received from the patient.

Although the invention has been described with reference to the preferred embodiment illustrated in the attached drawing figures, it is noted that equivalents may be employed and substitutions made herein without departing from the scope of the invention as recited in the claims.

1. A method of remotely filling a prescription for a patient, the method comprising the steps of:
(a) receiving the prescription;
(b) performing at least one drug utilization review based on the prescription;
(c) filling the prescription;
(d) providing the filled prescription to a local pharmacy; and
(e) receiving payment for the filled prescription from the patient.

2. The method of claim 1, wherein at least one part of the method is implemented by a computer program stored on a computer-readable medium for operating computing equipment.

3. The method of claim 2, wherein the computer program includes a web-server hosting a web-site.

4. The method of claim 2, wherein the drug utilization review is performed by the computer program.

5. The method of claim 1, wherein the prescription is received electronically.

6. The method of claim 5, wherein the prescription is received by a computer program stored on a computer-readable medium for operating computing equipment.

7. The method of claim 5, wherein the prescription is received as a scanned image.

8. The method of claim 1, wherein the prescription is filled by an automated filling system.

9. The method of claim 1, wherein at least a portion of the payment from the patient is made through a third party payer.

10. The method of claim 1, wherein the method includes the additional step of pricing the prescription.

11. A method of remotely filling a prescription for a patient, the method comprising the steps of:
(a) receiving a scanned image of the prescription from a local pharmacy;
(b) pricing the prescription;
(c) performing a first drug utilization review;
(d) performing a second drug utilization review;
(e) utilizing an automated filling system to fill the prescription;
(f) checking the filled prescription for accuracy;
(g) creating a document comprising information regarding the filled prescription, including a non-reproducible copy of the scanned image and a physical description of the filled prescription;
(h) sending the filled prescription and the document to the local pharmacy in a tamper evident package; and
(i) receiving payment for the filled prescription from the patient.

12. The method of claim 11, wherein at least one part of the method is implemented by a computer program stored on a computer-readable medium for operating computing equipment.

13. The method of claim 12, wherein the computer program includes a web-server hosting a web-site.

14. The method of claim 12, wherein the scanned image of the prescription is received by the computer program.

15. The method of claim 12, wherein the first drug utilization review is performed by the computer program.

16. The method of claim 12, wherein the second drug utilization review is performed by the computer program.

17. The method of claim 12, wherein the document comprising information regarding the filled prescription is created by the computer program.

18. The method of claim 12, wherein the payment from the patient is received by the computer program.

19. The method of claim 12, wherein the results of the first drug utilization review and second drug utilization review are stored by the computer program in the computer-readable medium.

20. The method of claim 12, wherein the results of the first drug utilization review and second drug utilization review are communicated to the local pharmacy by the computer program.

21. The method of claim 11, wherein at least a portion of the payment from the patient is made through a third party payer.

22. A method of remotely filling a prescription for a patient, the method comprising the steps of:
(a) receiving information from a local pharmacy through a computer program stored on a computer-readable medium for operating computing equipment, the information including a scanned image of the prescription and a name of the prescription.
(b) pricing the payment utilizing a third party benefit management company;
(c) performing a first drug utilization review with the computer program and communicating the results of the first drug utilization review to the local pharmacy;
(d) having a first remote pharmacist perform a second drug utilization review and communicating the results of the second drug utilization review to the local pharmacy;
(e) utilizing an automated filled system to interface with the computer program to fill the prescription;
(f) having a second remote pharmacist verify the accuracy of the filled prescription;
(g) generating a document with the computer program comprising information regarding the filled prescription, including a non-reproducible copy of the scanned image, a physical description of the filled prescription, and directions for using the filled prescription;
(h) sending the filled prescription and the document to the local pharmacy in a tamper evident package; and
(i) receiving payment for the filled prescription from the patient.

23. The method of claim 22, wherein the computer program includes a web-server operating a web-site.

24. The method of claim 22, wherein the computer program communicates the results of the first drug utilization review and second drug utilization review to the local pharmacy.

25. The method of claim 22, wherein at least a portion of the payment from the patient is made through a third party payer.
